(19) United States
(12) Patent Application Publication
(10) Pub. No.: US 2008/0255983 A1
(43) Pub. Date: Oct. 16, 2008

(54) SYSTEM AND METHOD FOR BAIT GENERATION

(75) Inventors: Anne von Corswant, Stockholm (SE); Greg Maynard, Port Washington, NY (US)

Correspondence Address: NIXON & VANDERHYE, PC, 901 NORTH GLEBE ROAD, 11TH FLOOR, ARLINGTON, VA, 22203, US

(73) Assignees: OMX Technology AB, Stockholm (SE); International Securities Exchange, New York, NY (US)

(21) Appl. No.: 12/061,299

(22) Filed: Apr. 2, 2008

Related U.S. Application Data
(60) Provisional application No. 60/907,500, filed on Apr. 5, 2007.

(51) Int. Cl. G06Q 40/00

(52) U.S. Cl. 705/37

(57) ABSTRACT

The present invention relates to a system and method for generating and managing bait orders in high performance computer systems, in particular it relates to a computer system and method for bait generation in high performance trading systems. The present invention removes bait orders when the base order has changed in such a way so that the bait order is not tradable. Thereafter the invention regenerates the bait order at a later time.

### CROSS-REFERENCE TO RELATED APPLICATION

This application claims priority from U.S. Provisional Patent Application No. 60/907,500, filed Apr. 5, 2007, the entire contents of that application is hereby incorporated by reference in its entirety.

### FIELD OF THE INVENTION

The present invention relates to a method and system that eases the burden on a processor in high performance computer systems, in particular it relates to a computer system and method for “bait order” generation in high performance trading systems.

### BACKGROUND OF THE INVENTION

It is known to use bait orders, for example Standard Combination limit orders that are stored in the order book for combination orders, may be subject for bait order generation. Bait orders are also referred to as “implied out orders” or “derived orders”. Such orders are generated by combining the stored standard combination order with the orders in the order books for each individual legs of the standard combination.

Thus, when bait orders can be generated, they are stored in the legs Order books as bait orders. The price and quantity of the bait orders are re-generated whenever the best single orders change or when the standard combination order changes.

If “real” orders exist that correspond to each leg in a combination order, all trades are performed simultaneously and the respective legs are updated as normal trades, thus preferably no bait orders are created. This is also the case if the combination order is matched against another combination order, the trade will be performed as one series and then divided into the respective legs, and no bait order is created.

In the USA, the spread used to be one tick size wide and therefore generation of baits have not been of great importance.

However the recent development of using smaller tick sizes such as allowing penny quoting at exchanges in the USA, has had the effect that the spread is now very often more than one tick wide (several pennies).

In known solutions baits are generated such that every time there is a new BBO or new BBO quantity, the baits are regenerated. With thousands and hundred thousands of updates per second for a liquid order book, there is simply no time for the current type of bait generation.

Thus, a drawback of existing solutions is that the bait generation is too cumbersome and takes too much processor time; this is a problem especially in high liquidity order books.

### BRIEF DESCRIPTION OF THE INVENTION

In this application some specific terms are used, below follows a description of these.

Bid: The price a buyer is willing to pay for a security.

Ask: The price a seller is willing to accept for a security.

Combination order: An order involving a number of different simultaneous trades of contracts is usually referred to as a combination order or a combination contract order. For example, a member may wish to buy 7 contracts A and sell 14 contracts B and not pay more than $100 for the whole combination contract. The amount that the member pays or receives when a combination order is traded is referred to the net price of the combination order.

Leg: Each product/sub-contract of the combination order is referred to as a leg or as an outright.

Bait order: Bait orders are not regarded as real orders; they are virtual orders acting for one of the legs in a combination order. The purpose of the bait order is to trigger a trade in the leg were no market price exists in order to execute the whole combination order.

Base order: Can be one or more orders and/or one or more quotes entered by a member, the order and quotes comprises at least a volume and a price. Preferably the base order is the best order or quote. A change in the base order may occur due to an amendment of the order or quote, a deletion of the order or quote, the order or quote is traded or a new order or quote is entered that is better and therefore takes the place of the first base order.

Thus it is an object of the present invention to provide a solution for generating bait orders in highly liquid order books.

It is another object of the present invention to provide a solution that uses less processor time.

It is another object of the present invention to minimize the spread in highly liquid order books.

It is another object of the present invention to limit the amount of data generated by the system in order to protect the bandwidth.

According to a first aspect of the invention the above object and advantages are achieved by providing a computer system for managing bait orders, the computer system comprising:
an interface for receiving a combination order and a base order,
a generator module for generating at least one bait order based on the combination order and the base order, and for placing the at least one bait order in an order book,
a management module for managing the generated bait order,
   wherein the management module removes the bait order from the order book when the bait is not tradable due to a change in the base order.

The computer system has the advantage that it makes it possible for a central computer system such as a trading system to minimize the number of processing steps so as to save processor time and thus ease the burden on a processor handling the orders and/or order books in the system. This is achieved by removing the bait order from the order book when the base order changes in such a way so that the bait order would become un-tradable if not removed. The bait order could also be frozen instead of removed and then activated in stead of regenerated. However this depends on how the market is moving.

Furthermore the computer system has the additional advantage of increasing the liquidity in the order book since generating bait orders in highly liquid order books narrows the spread and thereby even further increases the liquidity in the order book.

The base orders preferably comprise a price and a volume for an instrument traded in an order book. The base order is preferably a real order provided by a second member to an order book in the electronic exchange.

Preferably the combination order comprises at least two instruments (two legs) traded in two different order books, volume/volumes and a net price. However a combination order may comprise three, four, five or even more legs comprising different combinations.

The generator module preferably re-generates a new bait order after a time interval have passed from the removal of the bait order from the order book, and places the new bait order in the order book.

The time interval for regeneration of the bait order may be between 0.1 second to up to 5 seconds or even longer periods, preferably it is between 1 to 3 seconds before the new bait order is regenerated and inserted in the order book. In another preferred embodiment the regeneration is not time based, instead the bait order may be regenerated after x number of insertions of orders in the order book. X is an integer between 1 to 1000, preferably the integer is chosen between 10 to 100 or 100 to 200 or 200 to 300.

In a second aspect of the invention, the above and other objects are fulfilled by a computer system for managing bait orders, the computer system comprising:
an interface for receiving a combination order and a base order,
a generator module for generating at least one bait order based on the combination order and the base order, and for placing the at least one bait order in an order book,
a management module for managing the generated bait order,
   wherein the management module leaves the bait order in the order book until the bait is not tradable due to a change in the base order.

When the bait order becomes un-tradable the management module preferably removes the bait order by removing it or freezing it from the order book.

In a third aspect of the invention, the above and other objects are fulfilled by a financial trading system comprising any of the computer systems described above.

In a fourth aspect of the invention, the above and other objects are fulfilled by a method for managing bait orders, the method comprising the steps of:
receiving a combination order and a base order,
generating at least one bait order based on the combination order and the is base order,
placing the at least one bait order in an order book, and
removing the bait order from the order book when the bait is not tradable due to a change in the base order.

In a fifth aspect of the invention, the above and other objects are fulfilled by a method for managing bait orders, the method comprising the steps of:
receiving a combination order and a base order,
generating at least one bait order based on the combination order and the base order,
placing the at least one bait order in an order book, and
leaving the bait order in the order book until the bait is not tradable due to a change in the base order.

In a sixth aspect of the invention, the above and other objects are fulfilled by a computer readable memory comprising any of the methods described above.

Thus, instead of having the correct bait orders generated at all times, this method requires less calculations as less regeneration is made and the baits may not all the time have the best possible price. However, they are never showing a false price—any incoming order can trade at the price shown by the bait order or better.

In another embodiment the bait order may be generated on any of the existing base orders in the orderbooks related to the combination contract, and not only on the best order. Furthermore bait orders may be generated using another bait order as base order.

The baits may not only narrow the spread but also increase volume on an existing spread.

These and other aspects of the invention will be apparent from and elucidated with reference to the embodiments described hereinafter.

### BRIEF DESCRIPTION OF FIGURES

FIG. 1 illustrates a computer system according to the present invention.

FIG. 2 illustrates simplified order books for the combination order and for each leg in the combination order.

FIG. 3 illustrates simplified order books for the combination order and for each leg in the combination order.

### DESCRIPTION OF PREFERRED EMBODIMENTS

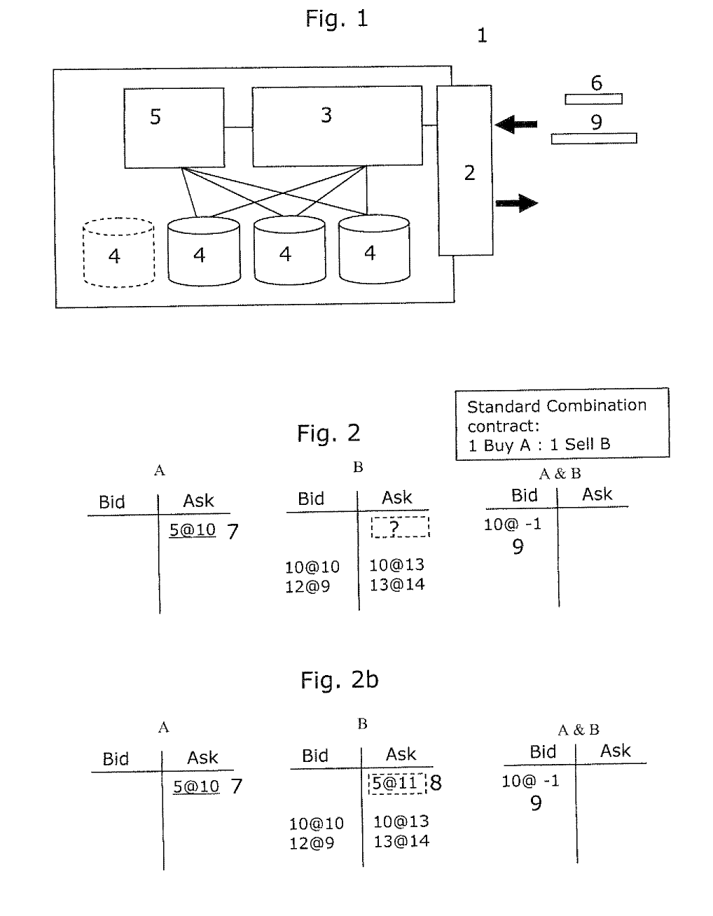

FIG. 1 illustrates a computer system 1 according to the present invention. The computer system comprising an interface 2 for receiving a combination order 9 from a first member and a base order 6 from a second member, a generator module 3 for generating at least one bait order based on the base order 6 and combination order 9, and for placing the at least one bait order in an order book 4, a management module 5 for managing the generated bait order 8. FIG. 1 only discloses three order books however more order books may be present as illustrated by the order book with dotted lines. Furthermore the computer system comprises one or more processors.

Preferably the computer system may comprise a server system comprising one or more processors configured to work as central market place for matching of financial instruments, such as stocks, options, bonds, swaps, repos or commodities such as energy, oil and so forth.

The computer system is connectable to a network, not illustrated in the figures. The network comprises conventional network means, as well as front end applications such as trading systems, and trading stations for sending in orders/quotes to the central market place.

The modules and interface comprises both hardware and software components. For example the generator module may comprise computer program or part of a computer program stored at a memory allocation and processing means that can access the computer program such that it can perform the methods according to the present invention. The processing means may be a standard Intel processor or the alike; the processor may be a multi-core processor.

FIG. 2 illustrates a simple example of bait generation based on a combination contract comprising a buy order for instrument A having ratio 1 and a sell order for instrument B having ratio 1, the net price for 10 combination order is −1 (BNP: Buy Net Price). Thus the buyer of the combination contract wants to obtain 1 when buying this standard combination contract.

BNP is calculated by addition of the buy orders (B) and subtracting the sell orders (S).

$$BNP = {\sum }_{1}^{N} B - {\sum }_{1}^{M} S$$

Thus in our case BNP=A−B=−1.

When such a “buy” combination order 9 enters the system, the system checks if it is possible to match the combination order with existing orders in order book A and order book B and/or with an existing corresponding sell combination order AB (which is sell A and buy B) in the combination order book.

If the combination order 9 is possible to match, no bait order is generated. However, if the combination order 9 can not be matched, the system preferably starts to check if bait orders can be generated. In this specific example there is an order in the order book for instrument A, where someone wants to sell A for a price of 10. This order 7 will be used as the base order for generating the bait order 8, as shown in FIG. 2b.

In order to make the example simple, the focus in this example will be on the price. The price 10 of the sell order 7 in order book A may be used as a base order value when generating the bait order. In order to match a “buy” combination order having a net price of −1, an order book B has to have a buy order with the price 11. The only orders that exist in order book B are two buy orders at the prices 10 and 9. Therefore the system generates a bait sell order having a price of 11, as shown in FIG. 2b.

This example also illustrates how bait orders decreases the spread. Before the spread for order book B was [10, 13] and after the bait order the spread is [10, 11].

Now the bait is in the order book and waiting for another member (aggressor) to hit the order. When an aggressor hits the bait order 8 the system replaces the bait order with a match between the incoming order, the combination order and the existing base order that was the base for the bait and the trade is completed and involved orders are removed from the order books.

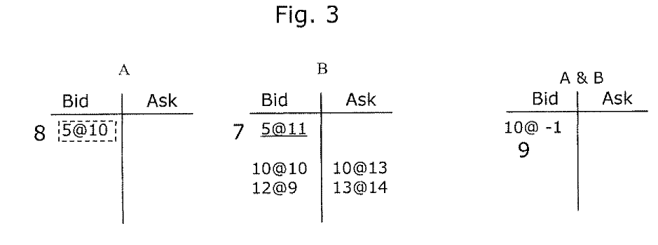

The whole volume of the combination order is not always traded at once, partial trades is also allowable as in the example shown in FIG. 2 to FIG. 3 where only 5 contracts of the combination order is traded.

There is a risk that the market may change resulting in change of the base order 7. The following example illustrates such an example for a specific case when an order in order book A comprises the base order. Let's say that the base order 7 is replaced by a new single order with a price of 9 instead of 10. In this specific example it is now possible to generate a new bait price as there is a better base order to use for the bait price generation. Based on a base order 7 having a price of 9, the price of the bait order 8 should change to 10 if the net price should be kept at −1. However according to the preferred embodiment the bait order is not regenerated since if the price of the bait order is kept at 11, an incoming aggressive order trying to match the bait order can still do so and thereby create a match between the incoming order, the combination and the existing sell order in order book A. The incoming aggressive order was prepared to buy B at 11, but will be buying at 10 which is a better price, or buying at 11 depending on how the rules are set at the exchange. Thus the bait order 8 is preferably not re-generated since the new situation is ok for everyone involved in the trade.

If the price of the base order 7 in A increases to 11, a different situation occurs. In order to obtain the net price −1 of the combination order the bait order has to change to 12. However according to the preferred embodiment this does not happen. Instead the computer system preferably removes the bait order as it can no longer serve its purpose.

The bait order is preferably regenerated after a certain time period that may be a predetermined period or decided by a user or it may be based on the activity in the market such as number of trades in a time interval and so forth. For example when the activity decreases below a certain level that could for example be X-orders/second, the bait order is regenerated and again put into the order book at another price depending on the order price of the base order value.

FIG. 3 illustrates a similar situation. However in FIG. 3 the order in the B order book constitutes the base order 7 for the generation of the bait order. Hence the bait order 8 is now the one in the A order book.

In this case if the base order 7 is replaced by another order at a price of 12 the bait order 8 in the A order book is kept since an aggressive incoming order prepared to sell A at 10 will now be matched on 11. However, if the price of the base order 7 in FIG. 3 decreases to 10 the price of the bait order 8 have to decrease to 9 in order to keep the net price value −1. However according to the preferred embodiment of the present invention the bait order will immediately be removed, as explained earlier.

Below follows further examples of how the invention may be used.

### Example of Implied-Out Bait Generation:

Buying a Nokia time spread means that the trader is selling the near month future on Nokia (here called Nokia C) and is buying the far month future on Nokia (here called Nokia D).

This is a simple example with only one bait order generated due to quite empty order books.

Assume the following layout of the two outright order books:

| | |
|---|---|
| Bid | Ask |

| Instrument | Price | Quantity | Price | Quantity |
|---|---|---|---|---|
| Nokia C | 100.00 | 10 | | |
| Nokia D | | | | |

A standard combination to buy a NOKIA D TS (the time spread) a price of 10.00 SEK and a quantity=5 is entered into the system.

As the combination can't match with the single order books and not with another combination, the order is stored in the combination order book:

| | |
|---|---|
| Bid | Ask |

| Instrument | Price | Quantity | Price | Quantity |
|---|---|---|---|---|
| Nokia D TS | 10.00 | 5 | | |

The bait generation can now start. Nokia D order book has no orders so a bait order can not be generated out from this order book. There is a bid on 100.00 SEK in Nokia C and that outright order could match with the combination order if there is someone sending in a sell order on Nokia D at a price of 110.00 SEK (−100+110=10 which is the price on the combination order). Therefore a bait order is placed in the Nokia D order book hoping that the lacking single limit order comes in. If that lacking order comes in, that order plus the base for the bait generation (the Nokia C bid) will match with the standard combination. The bait order has fulfilled its purpose—to be a bait for having the combo matched—and is deleted.

With Nokia C sell at 100.000 as a base order, a bait order can be stored and disseminated for Nokia D:

| | |
|---|---|
| Bid | Ask |

| Instrument | Price | Quantity | Price | Quantity |
|---|---|---|---|---|
| Nokia D | 110.00 | 5 | | |

This solution is less CPU intensive and Allows baits to be generated at a frequency that is less than every update of the BBO.

The baits are generated:
Either within the matching process if the combination order book and the outright order books are within the same partition.
Or outside the matching process and sent to the matching processes as “input bait order with this restrictions” if they are in different partitions.

The order books do not have to be within the same partition, thus the computer devices comprising the order books can be distributed in a network.

One or several baits are generated from the incoming combination order. A bait will stay as long as it is possible to trade the bait. The bait isn't regenerated when the base order of the generation changes to a value that still makes the bait price tradable.

Assume the following example with the standard combination order book and the two outright order books with the following layout (the bait order is shown in Italic):

| | |
|---|---|
| Bid | Ask |

| Instrument | Price | Quantity | Price | Quantity |
|---|---|---|---|---|
| Nokia D TS | 10.00 | 5 | | |
| Nokia C | 100.00 | 10 | | |
| Nokia D | 110.00 | 5 | | |

Assume that the Nokia C order book is updated with a new higher bid price (the base for the bait generation):

| | |
|---|---|
| Bid | Ask |

| Instrument | Price | Quantity | Price | Quantity |
|---|---|---|---|---|
| Nokia C | 110.00 | 10 | | |

In this case the bait in Nokia D is valid for 120.00 but the bait is not regenerated.

A base order can be increased on the buy side and decreased on the sell side without the need of regeneration the bait order. In the case above, and an incoming sell Nokia D at 110.00 is entered, the execution of this leg is done at 120.00—the price that would have been the case if the re-generation had taken place.

Then assume that the Nokia C order book is updated with a new lower bid price (the base for the bait generation) is:

| | |
|---|---|
| Bid | Ask |

| Instrument | Price | Quantity | Price | Quantity |
|---|---|---|---|---|
| Nokia C | 90.00 | 10 | | |

At this stage the bait order isn't possible to trade any longer and it is therefore deleted. A new bait generation is not made directly, but at a certain time interval later.

In the above description the term “comprising” does not exclude other elements or steps and “a” or “an” does not exclude a plurality.

Furthermore the terms “include” and “contain” does not exclude other elements or steps.

1. A computer system for managing bait orders, the computer system comprising:
an interface for receiving a combination order and a base order,
a generator module for generating at least one bait order based on the combination order and base order, and for placing the at least one bait order in an order book,
a management module for managing the generated bait order,
wherein the management module removes the bait order from the order book when the bait is not tradable due to a change in the base order.

2. A computer system according to claim 1, wherein the combination order comprises at least two legs and a net price.

3. A computer system according to claim 1, wherein the base order comprises a price for an instrument traded in an order book.

4. A computer system according to claim 1, wherein the generator module re-generates a new bait order after a time interval have passed from the removal of the bait order from the order book, and places the new bait order in the order book.

5. A computer system for managing bait orders, the computer system comprising:
an interface for receiving a combination order and a base order,
a generator module for generating at least one bait order based on the combination order and the base order, and for placing the at least one bait order in an order book,
a management module for managing the generated bait order,
wherein the management module leaves the bait order in the order book until the bait is not tradable due to a change in the base order.

6. A financial trading system comprising the computer system according to claim 1.

7. A method for managing bait orders, the method comprising the steps of:
receiving a combination order and a base order,
generating at least one bait order based on the combination order and the base order,
placing the at least one bait order in an order book, and
removing the bait order from the order book when the bait is not tradable due to a change in the base order.

8. A method for managing bait orders, the method comprising the steps of:
receiving a combination order and a base order,
generating at least one bait order based on the combination order and the base order,
placing the at least one bait order in an order book, and
leaving the bait order in the order book until the bait is not tradable due to a change in the base order.

9. A computer readable memory comprising the method according to claim 7.
